(19) United States
(12) Patent Application Publication
(10) Pub. No.: US 2017/0235047 A1
(43) Pub. Date: Aug. 17, 2017

(54) WAVEGUIDE

(71) Applicant: SUMITOMO BAKELITE CO., LTD., Tokyo (JP)

(72) Inventors: Katsuma KITAZOE, Tokyo (JP); Sho KUBOTA, Tokyo (JP); Masaaki KATO, Tokyo (JP)

(73) Assignee: SUMITOMO BAKELITE CO., LTD., Tokyo (JP)

(21) Appl. No.: 15/501,583

(22) PCT Filed: Jul. 31, 2015
(86) PCT No.: PCT/JP2015/071828

§ 371 Date: Feb. 3, 2017

(30) Foreign Application Priority Data
Aug. 4, 2014 (JP) 2014-158995

(51) Int. Cl. G02B 6/122; G02B 6/132

(52) U.S. Cl. CPC G02B 6/1228; G02B 6/132

(57) ABSTRACT

A waveguide 10 includes first core portions (cores 210) extending in a first direction (an x-axis direction), at least one second core portion (dummy cores 220) which is provided parallel to the first core portions (the cores 210) and extends in the first direction (the x-axis direction), and clad portions 230 that separate the first core portions (the cores 210) and the second core portions (the dummy cores 220), and the second core portion (the dummy core 220) has first regions (wave guide regions 240) having a substantially constant cross-sectional area and second regions (first light-shielding regions 252 and second light-shielding regions 254) which are continuously provided from at least one end of the first region (the wave guide region 240) and has a cross-sectional area that decreases as the second region runs farther away from the first region (the wave guide region 240). Therefore, the transmission of optical signals in the second core portions (the dummy cores) is prevented.

### TECHNICAL FIELD

The present invention relates to a waveguide.

### BACKGROUND ART

At the moment, optical communication technologies using waveguides have been developed. Waveguides have a core, and optical signals are transmitted through the core. In addition, there are cases in which multiple cores are arranged in order to transmit high-capacitance optical signals using waveguides. Meanwhile, when multiple cores are arranged, there are cases in which crosstalk occurs between cores adjacent to each other. In order to prevent the above-described crosstalk, there are cases in which, for example, dummy cores are provided between cores adjacent to each other as described in PTL 1. The dummy cores are cores that are not used for optical signal transmission and functions so as to prevent crosstalk between cores.

Meanwhile, PTL 2 describes a light source device including a light source and a light guide plate. The light source is provided close to the end surface of the light guide plate. In this case, the amount of light becomes excessive near the light source in the light guide plate, and there are cases in which brightness unevenness is caused. Therefore, in PTL 2, a dimming portion for decreasing the amount of light is provided in a portion close to the light source in the light guide plate.

### CITATION LIST

### Patent Literature

[PTL 1] Japanese Unexamined Patent Application Publication No. 2001-242332

[PTL 2] International Publication No. 2013/161941

### SUMMARY OF INVENTION

### Technical Problem

However, when the dummy cores as described in PTL 1 are provided, there are cases in which optical signals are transmitted not only through cores but also through the dummy cores.

The present invention has been made in consideration of the above-described circumstance, and an object of the present invention is to provide a waveguide in which the transmission of optical signals through dummy cores (second core portions) is prevented.

### Solution to Problem

According to the present invention, there is provided a waveguide including: first core portions extending in a first direction; at least one second core portion provided parallel to the first core portions and extending in the first direction; and a clad portion that separates the first core portions and the second core portion, in which the second core portion has a first region having a substantially constant cross-sectional area and a second region continuously provided from at least one end of the first region, and the second region having a cross-sectional area that decreases as the second region runs farther away from the first region.

### Advantageous Effects of Invention

According to the present invention, the transmission of optical signals through the second core portions (the dummy cores) is prevented.

### BRIEF DESCRIPTION OF DRAWINGS

FIG. 1 is a plan view illustrating a waveguide according to a first embodiment.

FIG. 2 is an enlarged view of a region surrounded by a dotted line α in FIG. 1.

FIG. 3 is an enlarged view of a region surrounded by a dotted line β in FIG. 2.

FIG. 4 is a cross-sectional view taken in a direction of A-A′ in FIG. 2.

FIG. 5 is a cross-sectional view taken in a direction of B-B′ in FIG. 2.

FIG. 6 is a cross-sectional view for describing a method for manufacturing a waveguide.

FIG. 7 is a plan view illustrating a waveguide according to a second embodiment.

FIG. 8 is an enlarged view of a region surrounded by a dotted line β in FIG. 7.

FIG. 9 is a cross-sectional view taken in a direction of C-C′ in FIG. 7.

FIG. 10 is a plan view illustrating a waveguide according to a third embodiment.

FIG. 11 is an enlarged view of a region surrounded by a dotted line β in FIG. 10.

FIG. 12 is a view illustrating a different constitution example of FIG. 1 of the first embodiment.

FIG. 13 is an enlarged view of a region surrounded by a dotted line α in FIG. 12.

FIG. 14 is a view illustrating a different constitution example of FIG. 4 of the first embodiment.

FIG. 15 is a view illustrating a different constitution example of FIG. 4 of the first embodiment.

FIG. 16 is a view illustrating a different constitution example of FIG. 4 of the first embodiment.

FIG. 17 is a view illustrating a different constitution example of FIG. 4 of the first embodiment.

FIG. 18 is a plan view illustrating a waveguide according to a fourth embodiment.

FIG. 19 is a plan view illustrating a waveguide according to a comparative example.

FIG. 20 is a graph illustrating a relationship between the number of light-shielding regions and the attenuation of light.

### DESCRIPTION OF EMBODIMENTS

Hereinafter, embodiments of the present invention will be described using the drawings. Furthermore, in all of the drawings, the same constituent element will be given the same reference signal and will not be described.

### First Embodiment

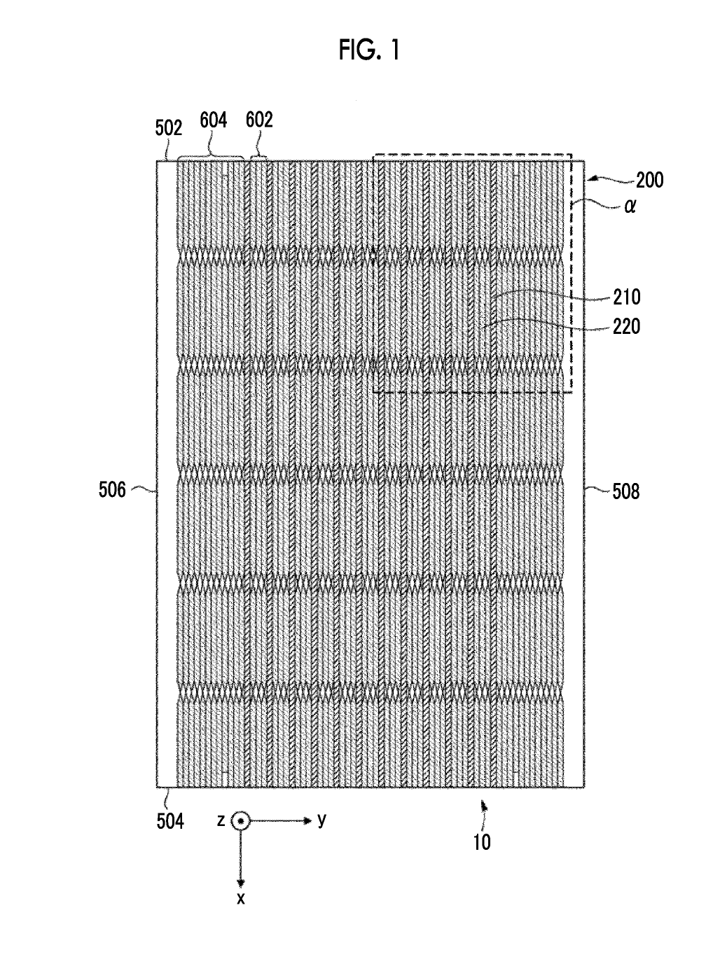

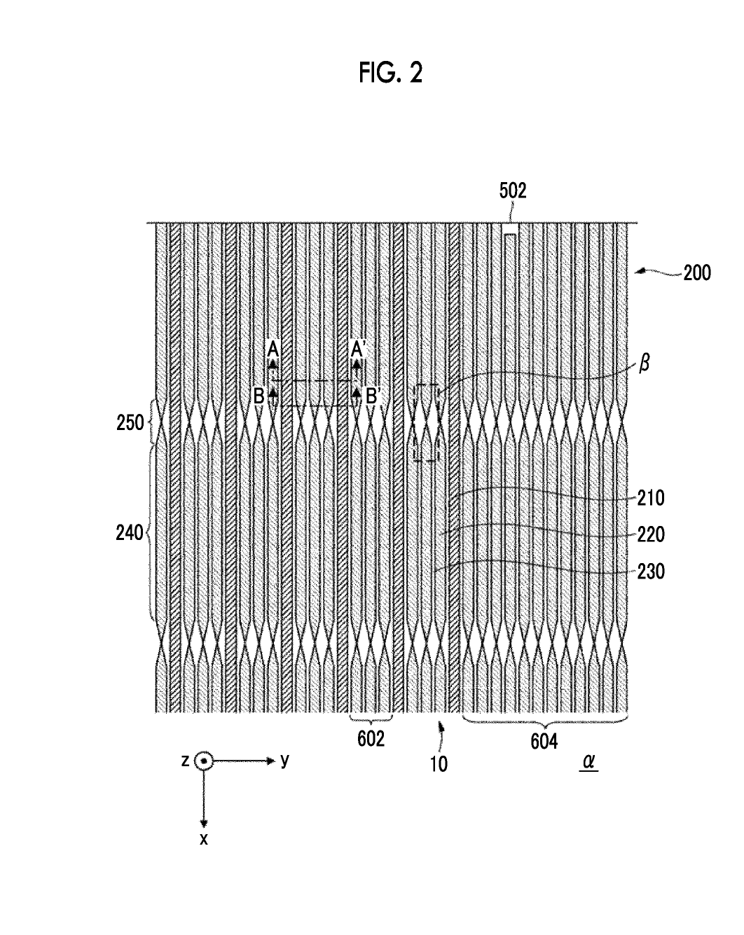

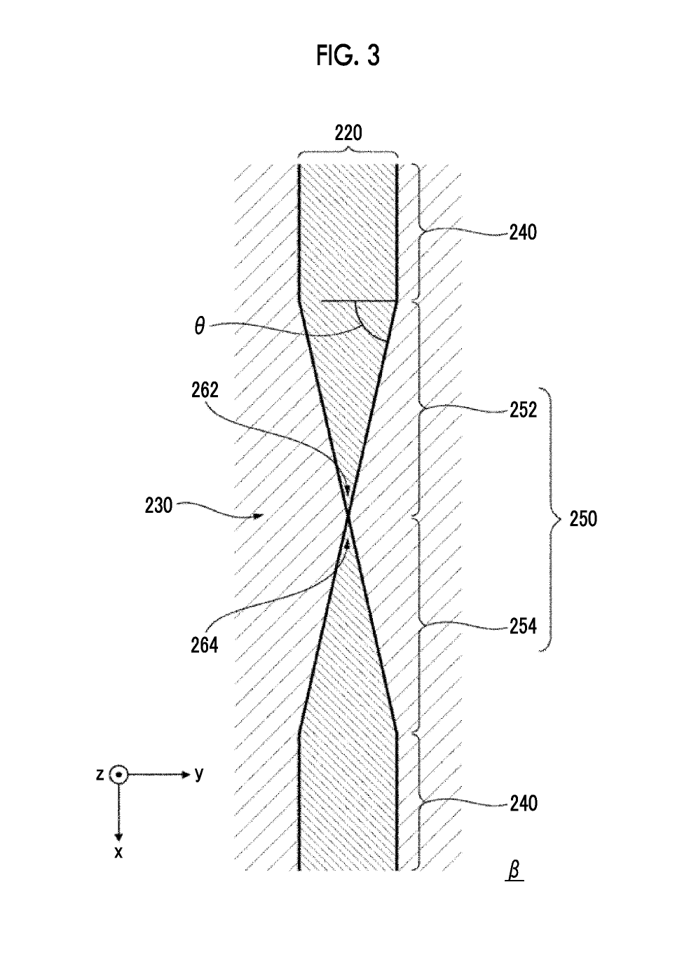

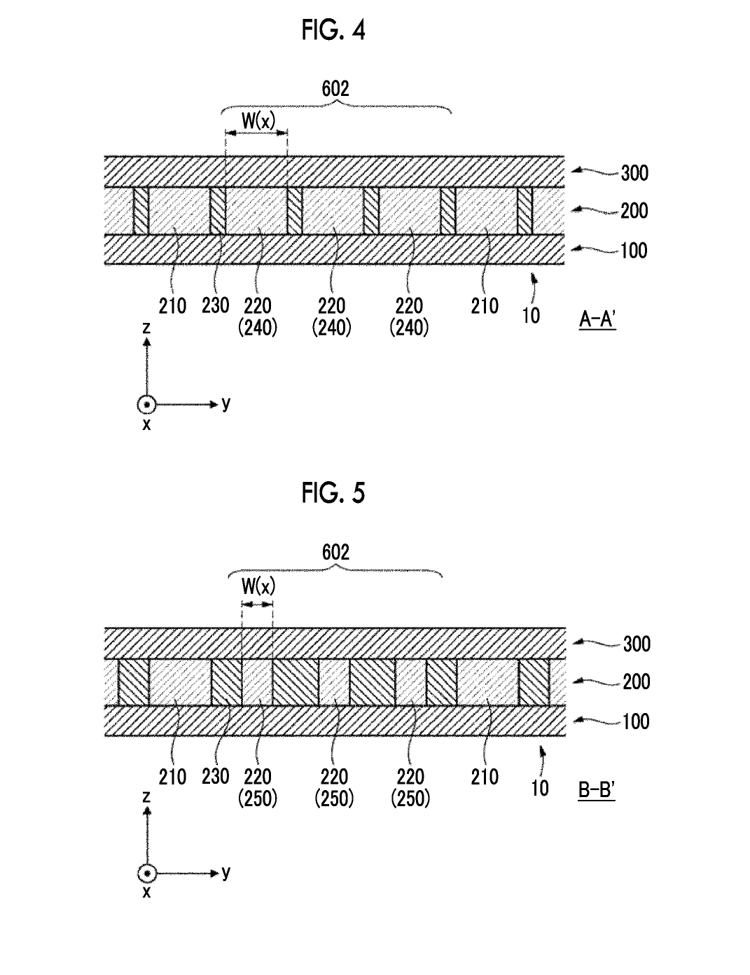

FIG. 1 is a plan view illustrating a waveguide 10 according to a first embodiment. FIG. 2 is an enlarged view of a region surrounded by a dotted line α in FIG. 1. FIG. 3 is an enlarged view of a region surrounded by a dotted line β in FIG. 2. FIG. 4 is a cross-sectional view taken in a direction of A-A′ in FIG. 2. FIG. 5 is a cross-sectional view taken in a direction of B-B′ in FIG. 2.

The waveguide 10 has a clad layer 100, a core layer 200, and a clad layer 300. The clad layer 100, the core layer 200, and the clad layer 300 are laminated in this order. The core layer 200 includes cores 210, dummy cores 220, and clad portions 230. The cores 210 are cores for optical signal transmission. In contrast, the dummy cores 220 are cores that are not used for optical signal transmission.

Meanwhile, in the following description, the longitudinal direction of the cores 210 and the dummy cores 220, which is a first direction in which the cores 210 and the dummy cores 220 extend, will be considered as “the x-axis direction”, the width direction of the cores 210 and the dummy cores 220, which is a second direction which intersects the first direction, will be considered as “the y-axis direction”, and the thickness direction of the core layer 200, which is a third direction which intersects both the first direction and the second direction, in other words, the lamination direction of the clad layer 100, the core layer 200, and the clad layer 300 will be considered as “the z-axis direction”.

In an example illustrated in FIGS. 1 to 5, the core 210 and the dummy core 220 respectively have, as a whole, a linear shape that extends in the x-axis direction. However, the shape of the core 210 and the dummy core 220 is not limited to that in the example illustrated in FIGS. 1 to 5 and may be, for example, curved in a portion in the x-axis direction. Hereinafter, a case in which the core 210 and the dummy core 220 respectively have, as a whole, a linear shape along the x-axis direction will be described.

The cores 210 and the dummy cores 220 are respectively sandwiched by two clad portions 230 in the y-axis direction in the core layer 200. Furthermore, the cores 210 and the dummy cores 220 are sandwiched by the clad layer 100 and the clad layer 300 in the z-axis direction. The refractive index of the core 210 and the dummy core 220 is higher than the refractive index of the clad portion 230 and the clad layers 100 and 300. Therefore, it is possible to confine light in the cores 210 and the dummy cores 220.

Meanwhile, the distribution of the refractive index from the core 210 and the dummy core 220 through the clad portion 230 and the clad layers 100 and 300 is not particularly limited, but it is possible to form, for example, a step index (SI)-type distribution or a graded index (GI)-type distribution. In addition, the difference (|ncore/nclad−1|×100(%)) between the refractive index ncore of the core 210 and the dummy core 220 and the refractive index nclad of the clad portion 230 and the clad layers 100 and 300 is preferably set to 0.3% or more and 5.5% or less.

In the example illustrated in FIGS. 1 to 5, the clad layer 100, the core layer 200, and the clad layer 300 have substantially the same planar shape. In addition, this planar shape is substantially a rectangle, and this rectangle has sides 502, 504, 506, and 508. The sides 502 and 504 face each other. The sides 506 and 508 face each other and are longer than the sides 502 and 504. Therefore, the direction along the sides 502 and 504 of the core layer 200 corresponds to “the y-axis direction” and the direction perpendicular to the sides 502 and 504 corresponds to “the x-axis direction”. However, the planar shapes of the clad layer 100, the core layer 200, and the clad layer 300 are not limited to a rectangle.

The core 210 (also referred to as “the first core portion”) extends in the x-axis direction, and both ends thereof reach the sides 502 and 504. In addition, the cross-sectional area of the core 210 is substantially constant from one end through the other end. In the example illustrated in FIGS. 1 to 5, the thickness and width of the core 210 are substantially constant from one end through the other end.

In each of the cores 210, the side surfaces facing each other in the y-axis direction are substantially parallel to each other in the z-axis direction. Furthermore, each of the cores 210 is formed from the bottom surface through the top surface of the core layer 200 and reaches the bottom surface and the top surface of the core layer 200. Therefore, each of the cores 210 has a substantially rectangular shape on a cross-section (an intersection surface) perpendicular to the x-axis direction. Meanwhile, the cores 210 may not reach the bottom surface and the top surface of the core layer 200.

In the core layer 200, multiple cores 210 are repetitively arranged in the y-axis direction at substantially equal intervals. These cores 210 have substantially the same length and have substantially the same thickness and width. Meanwhile, the core layer 200 may include two cores 210. In this case, the two cores 210 are arranged in the y-axis direction at an appropriate interval.

The dummy cores 220 are provided separately from each other in the y-axis direction in interval regions 602 and an outside region 604 respectively. The interval region 602 is a region between the cores 210 adjacent to each other. The outside region 604 is a region located outside all of the cores 210 in a direction in which the multiple cores 210 are arranged and which corresponds to the y-axis direction. In both the interval regions 602 and the outside region 604, the dummy cores 220 are provided parallel to the cores 210 and extend in the x-axis direction from the side 502 through the side 504 of the core layer 200.

The respective dummy cores 220 are formed from the bottom surface through the top surface of the core layer 200 and reach the bottom surface and the top surface of the core layer 200. In addition, in each of the dummy cores 220, the side surfaces facing each other in the y-axis direction are substantially parallel to each other in the z-axis direction. Therefore, each of the dummy cores 220 has a substantially rectangular shape on a cross-section (an intersection surface) perpendicular to the x-axis direction. Meanwhile, the dummy cores 220 may not reach the bottom surface and the top surface of the core layer 200.

In the example illustrated in FIGS. 1 to 5, the multiple dummy cores 220 are located in the interval regions 602. However, the number of the dummy cores 220 included in the interval region 602 is not limited to be multiple and may be one.

Furthermore, in the example illustrated in FIGS. 1 to 5, in the interval regions 602, the dummy cores 220 have substantially the same length, and both ends of the dummy cores 220 reach the sides 502 and 504 of the core layer 200. However, both ends of the dummy cores 220 may not reach the sides 502 and 504. That is, the length of the dummy cores 220 in the interval regions 602 may be shorter than the length of the cores 210.

Furthermore, in the example illustrated in FIGS. 1 to 5, the multiple dummy cores 220 are also located in the outside region 604. In addition, out of these multiple dummy cores 220, the length of some of the dummy cores 220 is shorter than the length of the other dummy cores 220. In this case, the cores 210 are located inside the short dummy cores 220. That is, the short dummy cores 220 function as a landmark indicating the location of the cores 210.

Each of the dummy cores 220 includes wave guide regions 240 and light-shielding regions 250 that are continuously provided from the wave guide region 240. In the wave guide regions 240, the thickness and width W(x) are substantially constant. In contrast, in the light-shielding regions 250, the thickness is substantially constant, but the width W(x) changes from the side 502 toward the side 504 of the core layer 200.

The light-shielding region 250 includes a first light-shielding region 252 and a second light-shielding region 254 (also referred to as “the second regions” respectively) which are continuously provided from the wave guide regions 240 (also referred to as “the first regions”). The first light-shielding region 252 and the second light-shielding region 254 are arranged in this order from the side 502 toward the side 504 of the core layer 200. In the first light-shielding region 252, the thickness is substantially constant, but the width W(x) narrows from the side 502 toward the side 504. In contrast, in the second light-shielding region 254, the thickness is substantially constant, but the width W(x) widens from the side 502 toward the side 504. That is, in both the first light-shielding region 252 and the second light-shielding region 254, the thickness is substantially constant, but the width W(x) decreases as the light-shielding region runs farther away from the wave guide region 240. Meanwhile, in the first light-shielding region 252 and the second light-shielding region 254, W(x) can be indicated by a continuous function (for example, a trigonometric function or a polynomial expression) regarding x, but the indication method is not limited thereto.

The first light-shielding region 252 is connected to the wave guide region 240 located opposite to the second light-shielding region 254 through the first light-shielding region 252. Similarly, the second light-shielding region 254 is connected to the wave guide region 240 located opposite to the first light-shielding region 252 through the second light-shielding region 254.

In other words, the respective dummy cores 220 are provided parallel to the cores 210 and include multiple dummy units (also referred to as “the second core portions”) that extend in the x-axis direction. Specifically, the multiple dummy core units include one first dummy core unit, one second dummy core unit, and multiple (four in the present embodiment) third dummy core units which are provided in the x-axis direction respectively. The first dummy core unit is located closest to the side 502, the second dummy core unit is located closest to the side 504, and the respective third dummy core units are located between the first dummy core unit and the second dummy core unit.

The first dummy core unit, the second dummy core unit, and the third dummy core unit respectively have different shapes when seen in the z-axis direction (in a planar view of the waveguide 10). Specifically, the first dummy core unit includes the wave guide region 240 and the first light-shielding region 252 continuously provided from one end of the wave guide region 240 on the side 504 side. The second dummy core unit includes the wave guide region 240 and the second light-shielding region 254 continuously provided from one end of the wave guide region 240 on the side 502 side. Each of the third dummy core units includes the wave guide region 240 and the first light-shielding region 252 and the second light-shielding region 254 continuously provided from two ends (one end on the side 504 side and one end on the side 502 side) of the wave guide regions 240 respectively.

When seen in the z-axis direction, the respective side surfaces of the first light-shielding region 252 have a linear shape. In addition, the respective side surfaces of the first light-shielding region 252, when seen in the z-axis direction, are inclined toward the inside of the dummy cores 220, that is, the central line of the dummy cores 220 as the side surfaces run from the wave guide region 240 toward the second light-shielding region 254.

As illustrated in FIG. 3, in a case in which the angle formed between each of the side surfaces of the first light-shielding region 252 and the y-axis direction is represented by the angle θ, light transmitted through the dummy core 220 in the x-axis direction from the side 502 side of the core layer 200 is incident on the clad portion 230 from the side surface of the first light-shielding region 252 at the angle θ. The angle θ is preferably set to be, for example, larger than the acceptance angle (θmax) of the numerical aperture (NA=sin θmax) of the dummy core 220 and the clad portion 230. Specifically, the angle θ is preferably 5° or more and less than 90°, more preferably 5° or more and 45° or less, and still more preferably 8° or more and 20° or less.

When seen in the z-axis direction, the respective side surfaces of the second light-shielding region 254 also have a linear shape. In addition, the respective side surfaces of the second light-shielding region 254, when seen in the z-axis direction, are inclined toward the inside of the dummy cores 220, that is, the central line of the dummy cores 220 as the side surfaces run from the wave guide region 240 toward the first light-shielding region 252. In the example illustrated in FIGS. 1 to 5, the planar shape of the second light-shielding region 254 is substantially symmetric to the planar shape of the first light-shielding region 252 with respect to a linear line penetrating between the first light-shielding region 252 and the second light-shielding region 254 in the y-axis direction.

When seen in the z-axis direction, both side surfaces of the first light-shielding region 252 intersect each other at a sharp angle on the second light-shielding region 254 side and form an end 262 at the intersection point. Similarly, when seen in the z-axis direction, both side surfaces of the second light-shielding region 254 intersect each other at a sharp angle on the first light-shielding region 252 side and form an end 264 at the intersection point. In addition, the ends 262 and 264 are connected to each other (are in contact with each other) at approximately the center of the dummy core 220 in the y-axis direction (substantially on the central line of the dummy core 220). That is, when seen in the z-axis direction (in a planar view of the waveguide 10), all of the first dummy core unit, the second dummy core unit, and the third dummy core unit have a substantially linear-symmetric shape with respect to the central line. However, the shapes of the first light-shielding region 252 and the second light-shielding region 254 are not limited thereto. For example, the ends 262 and 264 may curve (round) so as to form protrusions on the second light-shielding region 254 side and the first light-shielding region 252 side when seen in the z-axis direction.

In the example illustrated in FIGS. 1 to 5, each of the dummy cores 220 includes multiple light-shielding regions 250. In addition, these multiple light-shielding regions 250 are repetitively provided in the x-axis direction at substantially equal intervals through the wave guide region 240. Furthermore, in the multiple dummy cores 220, the disposition locations and the disposition intervals of the light-shielding regions 250 are set to be substantially equal. Therefore, the light-shielding regions 250 provided at substantially the same disposition locations are located on substantially a straight line in the y-axis direction. However, the number of the light-shielding regions 250 included in the dummy core 220 is not limited to that in the examples illustrated in FIGS. 1 to 5 and may be, for example, only one.

Furthermore, in the example illustrated in FIGS. 1 to 5, the regions of the dummy core 220 excluding the light-shielding regions 250 (the wave guide regions 240) have a width that is substantially the same as the width of the core 210. In addition, the multiple cores 210 and the multiple dummy cores 220 are arranged at substantially equal intervals in the y-axis direction. Meanwhile, the width of the dummy core 220 is not limited to that in the example illustrated in FIGS. 1 to 5. For example, the width of the dummy core 220 may be narrower than the width of the core 210. In this case, it is possible to decrease the widths of the regions in the core layer 200 which are occupied by the dummy cores 220. Therefore, it is possible to dispose a large number of the cores 210 at a high density in the core layer 200.

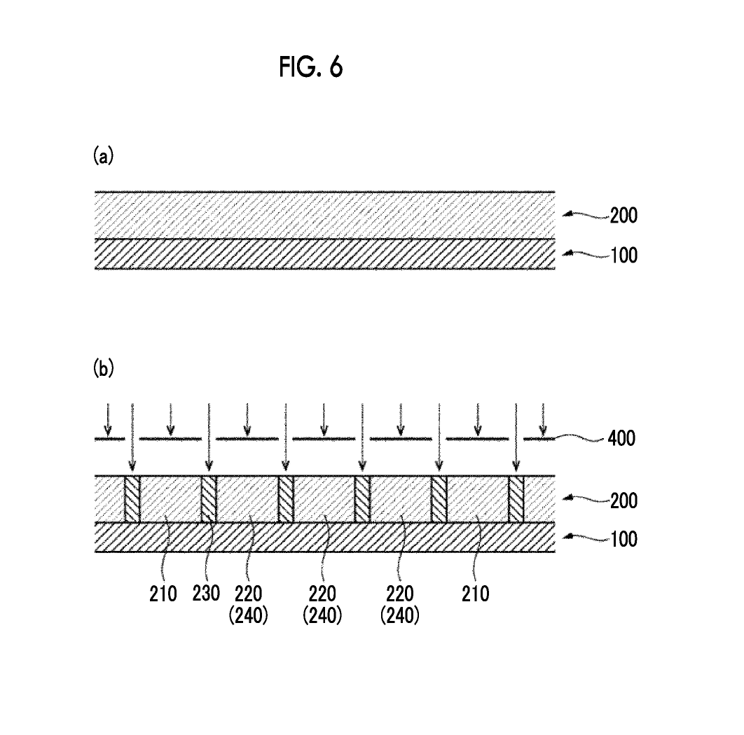

FIG. 6 is a cross-sectional view for describing a method for manufacturing the waveguide 10. FIG. 6 corresponds to a cross-sectional view taken in a direction of A-A′ in FIG. 2. Meanwhile, the method for manufacturing the waveguide 10 is not limited to the example illustrated in FIG. 6.

First, the clad layer 100 is prepared. The clad layer 100 can be formed using, for example, a (meth)acrylic resin, an epoxy-based resin, a silicone-based resin, a polyimide-based resin, a fluorine-based resin, or a polyolefin-based resin. In more detail, the clad layer 100 is preferably formed using, for example, polynorbornene. However, the material of the clad layer 100 is not limited thereto.

Next, as illustrated in FIG. 6(a), the core layer 200 is formed on the clad layer 100. The core layer 200 can be formed using a polymer in which a light-polymerizable monomer is dispersed. A polymer of this monomer has a lower refractive index than the above-described polymer. As the polymer for the core layer 200, it is possible to use, for example, a (meth) acrylic resin, an epoxy-based resin, a silicone-based resin, a polyimide-based resin, a fluorine-based resin, or a polyolefin-based resin. In more detail, as the polymer for the core layer 200, for example, polynorbornene is preferably used. As the monomer for the core layer 200, it is possible to use, for example, a norbornene-based monomer, an acrylic acid (methacrylic acid)-based monomer, an epoxy-based monomer, or a styrene-based monomer. In more detail, as the monomer for the core layer 200, for example, an oxetane monomer is preferably used. However, the materials of the polymer and the monomer are not limited thereto.

Next, as illustrated in FIG. 6(b), a mask 400 is disposed in a location facing the clad layer 100 through the core layer 200. In the example illustrated in FIG. 6(b), the mask 400 has a shape that covers regions in the core layer 200 in which the cores 210 and the dummy cores 220 are formed.

Next, light (for example, visible light, infrared rays, or ultraviolet rays) is radiated on the core layer 200 through the mask 400. In this case, in the exposed region of the core layer 200, a polymerization reaction of the above-described monomer is caused. Therefore, the concentration of the monomer in the exposed region decreases. Therefore, the monomer in the non-exposed region diffuses into the exposed region. The diffused monomer causes another polymerization reaction in the exposed region. As a result, the polymer is mainly present in the non-exposed region and thus the non-exposed region becomes a high-refractive index region, and a polymer of the monomer is mainly present in the exposed region and thus the exposed region becomes a low-refractive index region. As a result, the cores 210 and the dummy cores 220 are formed in the non-exposed region, and the clad portions 230 are formed in the exposed region.

Next, the clad layer 300 is formed on the core layer 200. Therefore, the waveguide 10 is obtained. The clad layer 300 can be formed using, for example, a (meth)acrylic resin, an epoxy-based resin, a silicone-based resin, a polyimide-based resin, a fluorine-based resin, or a polyolefin-based resin. In more detail, the clad layer 300 is preferably formed using, for example, polynorbornene.

Next, the actions and effects of the present embodiment will be described. In the present embodiment, the core layer 200 has a planar shape including the sides 502 and 504 which are substantially parallel to each other. In addition, in the core layer 200, the multiple cores 210 are arranged separately from each other in the y-axis direction. The respective cores 210 extend in the x-axis direction from the side 502 toward the side 504. In addition, the thickness and width of each of the cores 210 are substantially constant from one end through the other end. Therefore, these multiple cores 210 are capable of transmitting optical signals from the side 502 to the side 504.

The multiple dummy cores 220 are formed separately from each other in the y-axis direction in the core layer 200. The respective dummy cores 220 extend in the x-axis direction from the side 502 toward the side 504. In addition, the dummy core 220 is located between the cores 210 adjacent to each other. In addition, the clad portion 230 that separates the dummy core 220 and the core 210 and separates the dummy cores 220 is located between the dummy core 220 and the core 210 and between the dummy cores 220. In this case, it is considered that light leaked from the cores 210 due to crosstalk diffuses and is reflected in the interfaces between the dummy cores 220 and the clad portions 230. Therefore, crosstalk between the cores 210 adjacent to each other can be prevented using the dummy cores 220. Meanwhile, the dummy cores 220 are cores that are not used for optical signal transmission.

Each of the dummy cores 220 includes the first light-shielding regions 252 and the second light-shielding regions 254. The first light-shielding region 252 and the second light-shielding region 254 are arranged in this order from the side 502 toward the side 504. The thicknesses of the first light-shielding region 252 and the second light-shielding region 254 are substantially constant. In the first light-shielding region 252, the width narrows as the first light-shielding region runs from the side 502 toward the side 504. In contrast, in the second light-shielding region 254, the width widens as the second light-shielding region runs from the side 502 toward the side 504.

When seen in the z-axis direction, the respective side surfaces of the first light-shielding regions 252 and the second light-shielding regions 254 are inclined with respect to the sides 502 and 504 and the x-axis direction. Therefore, it is considered that light guided in the dummy cores 220 in the x-axis direction diffuses and is reflected on the side surfaces of the first light-shielding regions 252 and the second light-shielding regions 254. Therefore, it is possible to prevent light input to the dummy cores 220 from the side 502 side from being transmitted up to the side 504.

Furthermore, in the example illustrated in FIGS. 1 to 5, when seen in the z-axis direction, the respective side surfaces of the first light-shielding regions 252 are inclined at the angle θ with respect to the y-axis direction. In this case, light transmitted in the dummy cores 220 from the side 502 side of the core layer 200 in the x-axis direction is incident on the clad portions 230 from the side surfaces of the first light-shielding region 252 at the angle θ. The angle θ is preferably set to be larger than the acceptance angle (θmax) of the numerical aperture (NA=sin θmax) of the dummy core 220 and the clad portion 230. In this case, light transmitted through the dummy cores 220 from the side 502 side of the core layer 200 in the x-axis direction is incident on the clad portions 230 without being fully reflected on the interfaces between the side surfaces of the first light-shielding region 252 and the clad portions 230. Therefore, it is possible to more effectively prevent light input to the dummy cores 220 from the side 502 side from being transmitted up to the side 504.

### Second Embodiment

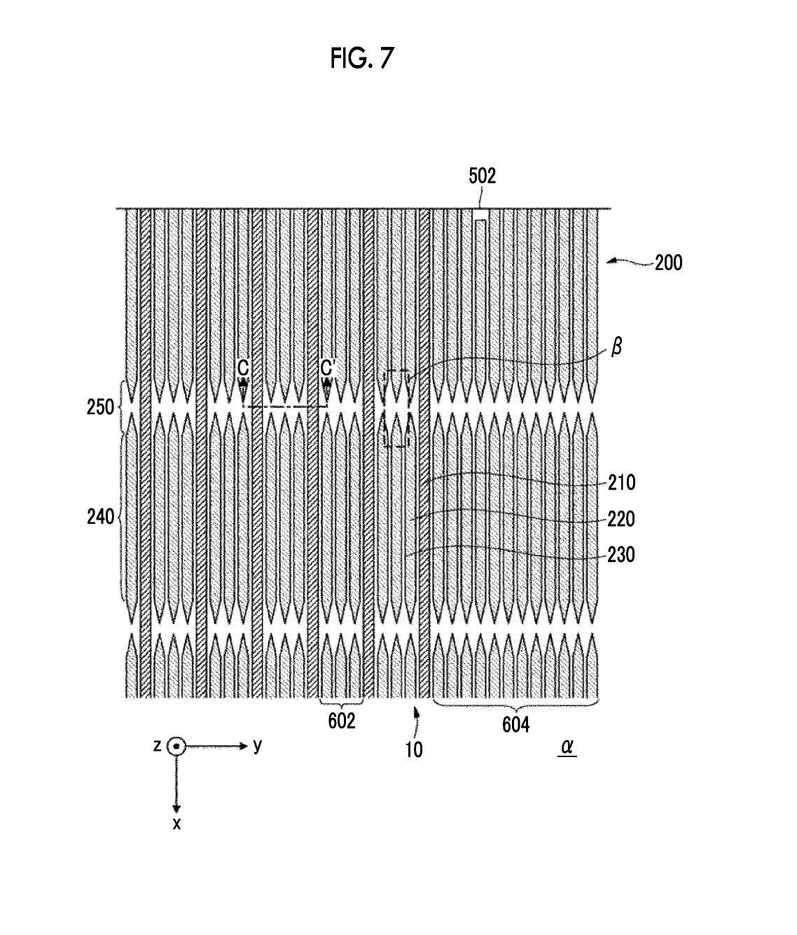

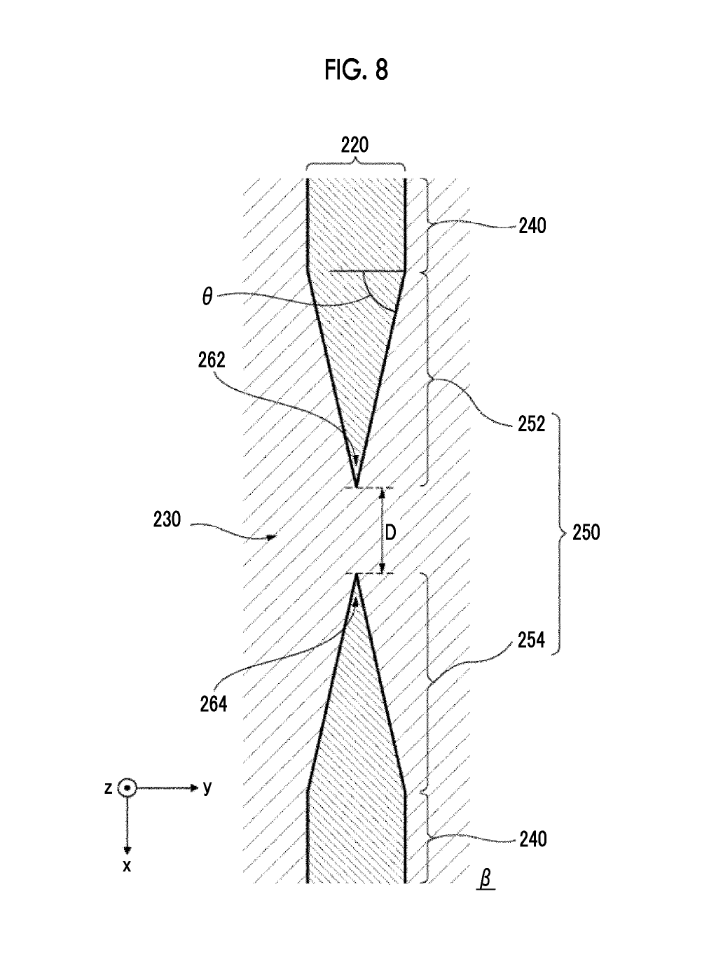

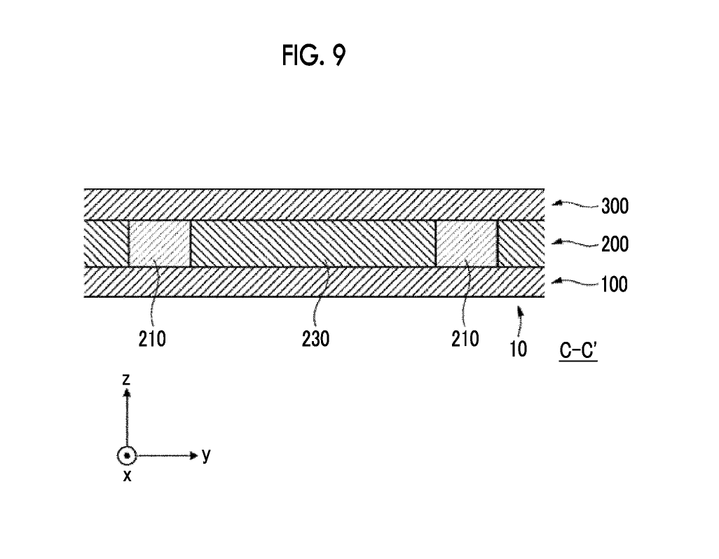

FIG. 7 is a plan view illustrating the waveguide 10 according to a second embodiment and corresponds to FIG. 2 of the first embodiment. FIG. 8 is an enlarged view of a region surrounded by a dotted line β in FIG. 7 and corresponds to FIG. 3 of the first embodiment. FIG. 9 is a cross-sectional view taken in a direction of C-C′ in FIG. 7. The waveguide 10 according to the present embodiment has the same constitution as that of the waveguide 10 according to the first embodiment except for the fact that the ends 262 of the first light-shielding regions 252 and the ends 264 of the second light-shielding regions 254 are separated from each other.

In detail, the waveguide 10 includes the dummy cores 220 in the core layer 200. Each of the dummy cores 220 includes the first light-shielding region 252 and the second light-shielding region 254. The first light-shielding region 252 and the second light-shielding region 254 are arranged in this order in the x-axis direction of each of the dummy cores 220.

The first light-shielding region 252 is connected to the wave guide region 240 located opposite to the second light-shielding region 254 through the first light-shielding region 252. Similarly, the second light-shielding region 254 is connected to the wave guide region 240 located opposite to the first light-shielding region 252 through the second light-shielding region 254.

In the wave guide region 240, the thickness and width are substantially constant. In contrast, in the first light-shielding region 252, the thickness is substantially constant, but the width narrows from the wave guide region 240 connected to the first light-shielding region 252 toward the second light-shielding region 254. Furthermore, in the second light-shielding region 254, the thickness is substantially constant, but the width widens from the first light-shielding region 252 to the wave guide region 240 connected to the second light-shielding region 254.

When seen in the z-axis direction, both side surfaces of the first light-shielding region 252 intersect each other at a sharp angle on the second light-shielding region 254 side and form the end 262 at the intersection point. Similarly, when seen in the z-axis direction, both side surfaces of the second light-shielding region 254 intersect each other at a sharp angle on the first light-shielding region 252 side and form the end 264 at the intersection point. However, the shapes of the first light-shielding region 252 and the second light-shielding region 254 are not limited thereto. For example, the ends 262 and 264 may curve (round) so as to form protrusions on the second light-shielding region 254 side and the first light-shielding region 252 side when seen in the z-axis direction.

The end 262 and the end 264 which are adjacent to each other are separated from each other a distance D in the x-axis direction. That is, two dummy core units adjacent to each other are separated from each other the distance D in the x-axis direction. In addition, the clad portion 230 is located between the end 262 (the first light-shielding region 252) and the end 264 (the second light-shielding region 254), that is, between the dummy core units. The distance D is preferably set to 5 μm or more and 1,000 μm or less.

In the example illustrated in FIGS. 7 and 8, the ends 262 and 264 are located on substantially a straight line in the x-axis direction. Specifically, the ends 262 and 264 are located at approximately the center of the dummy core 220 in the y-axis direction (substantially on the central line of the dummy core 220). However, the locations of the ends 262 and 264 are not limited to those in the example illustrated in FIGS. 7 and 8. For example, the ends 262 and 264 may not be aligned with each other in the y-axis direction.

In the present embodiment as well, the same effects as those of the first embodiment can be obtained.

### Third Embodiment

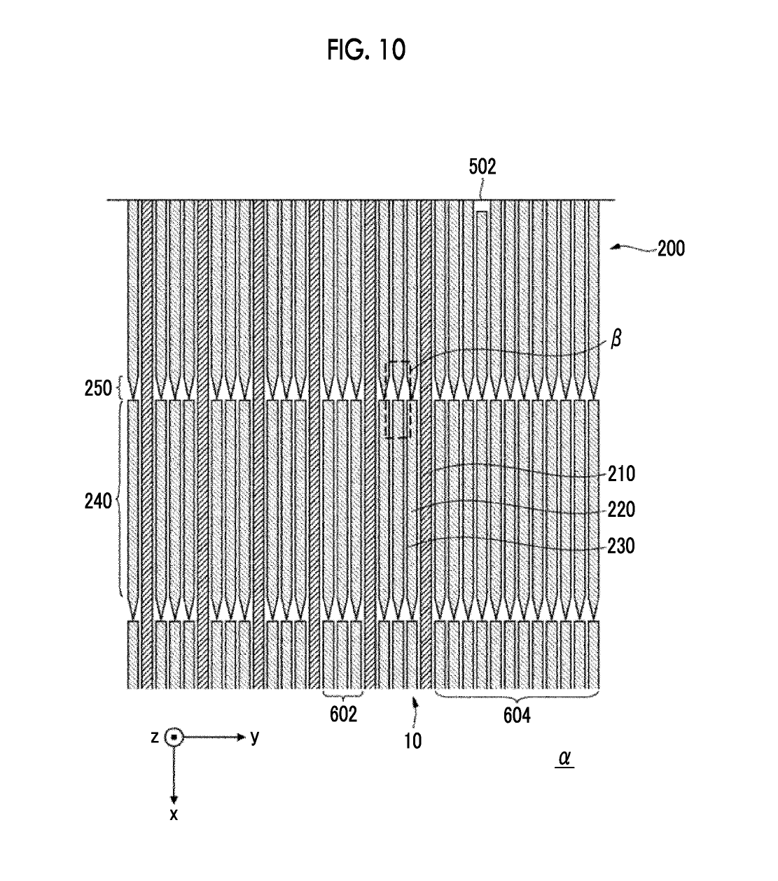

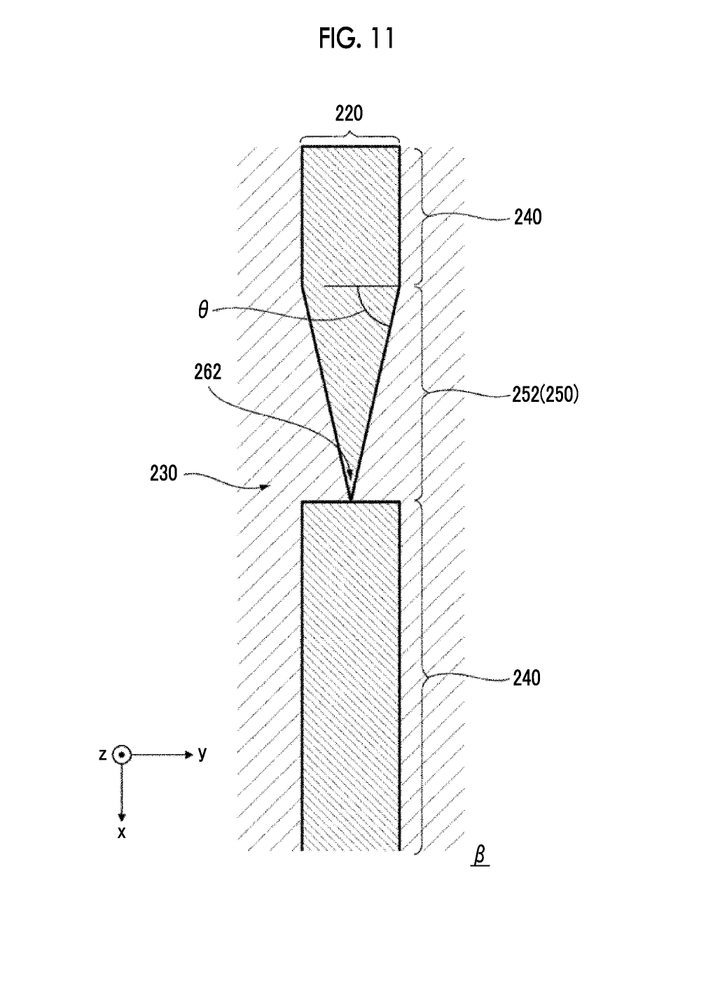

FIG. 10 is a plan view illustrating the waveguide 10 according to a third embodiment and corresponds to FIG. 2 of the first embodiment. FIG. 11 is an enlarged view of a region surrounded by a dotted line β in FIG. 10 and corresponds to FIG. 3 of the first embodiment. The waveguide 10 according to the present embodiment has the same constitution as that of the waveguide 10 according to the first embodiment except for the following facts.

The waveguide 10 includes the dummy cores 220 in the core layer 200. Each of the dummy cores 220 includes the wave guide regions 240 and the first light-shielding regions 252, but does not include the second light-shielding regions 254 as illustrated in FIG. 3. That is, in the present embodiment, each of the dummy cores 220 includes the multiple first dummy core units, but does not include the second dummy core unit and the third dummy core unit.

In detail, the wave guide regions 240 and the first light-shielding regions 252 are arranged in this order in the x-axis direction of the dummy cores 220. The wave guide region 240 and the first light-shielding region 252 are connected to each other.

In the wave guide region 240, the thickness and width are substantially constant. In contrast, in the first light-shielding region 252, the thickness is substantially constant, but the width narrows from the wave guide region 240 on the side 502 side toward the wave guide region 240 on the side 504 side. Therefore, when seen in the z-axis direction, in the wave guide region 240, the end surface opposite to the first light-shielding region 252 connected to the wave guide region is substantially parallel to the y-axis direction.

When seen in the z-axis direction, both side surfaces of the first light-shielding region 252 intersect each other at a sharp angle on a side opposite to the wave guide region 240 connected to the first light-shielding region 252 and form the end 262 at the intersection point. However, the shape of the first light-shielding region 252 is not limited thereto. For example, the end 262 may curve (round) so as to forma protrusion on the wave guide region 240 side adjacent to the end (a side opposite to the wave guide region 240 connected to the first light-shielding region 252) when seen in the z-axis direction.

In the example illustrated in FIGS. 10 and 11, the end 262 is in contact with the wave guide region 240 adjacent to the end. That is, in the two first dummy core units adjacent to each other in the x-axis direction (the second core portions), the wave guide region 240 in one first dummy core unit (the first region) and the first light-shielding region 252 in the other first dummy core unit (the second region) are in contact with each other. However, the end 262 may be separated from the wave guide region 240 adjacent to the end. In a case in which the end 262 and the wave guide region 240 adjacent to the end are separated from each other, the separation distance is preferably set to 5 μm or more and 1,000 μm or less in the x-axis direction.

In the present embodiment as well, the same effects as those of the first embodiment can be obtained. Meanwhile, in the present embodiment, for example, light is input from the side 502 (FIG. 1) and is output from the side 504 (FIG. 1).

### Different Constitution Example 1

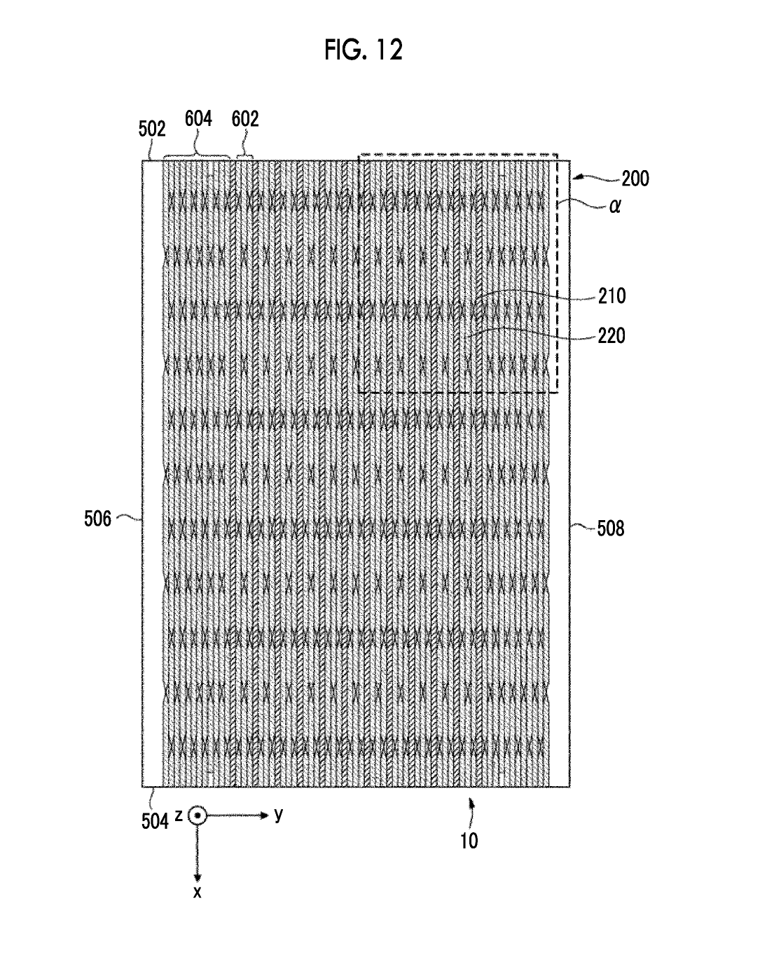

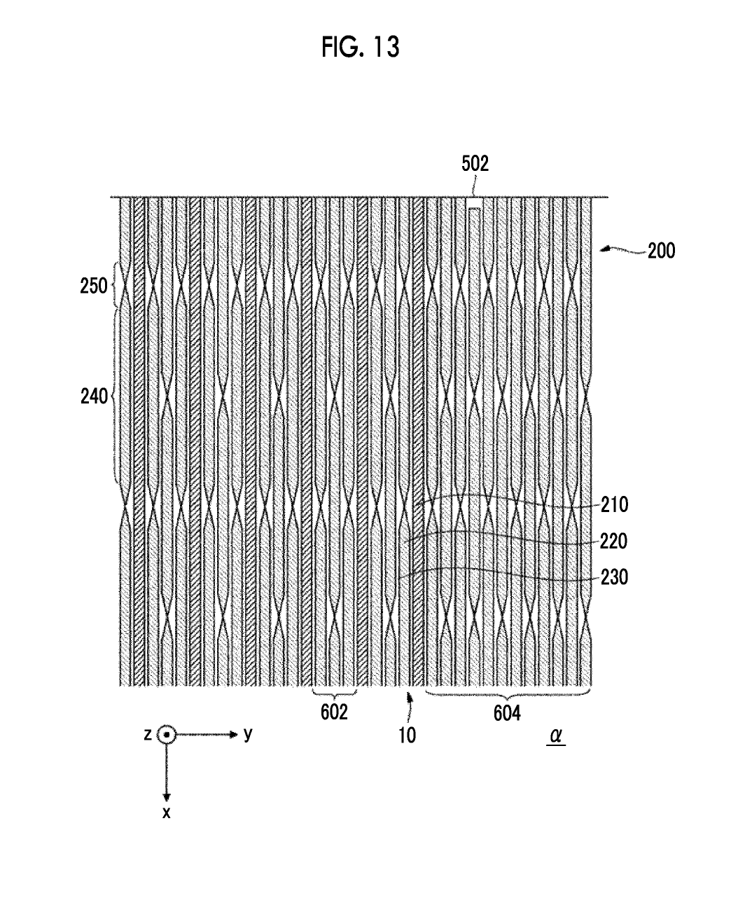

FIG. 12 is a view illustrating a different constitution example of FIG. 1 of the first embodiment. FIG. 13 is an enlarged view of a region surrounded by a dotted line α in FIG. 12 and corresponds to FIG. 2 of the first embodiment. The present constitution example is the same as the first embodiment except for the fact that, in the dummy cores 220 adjacent to each other, the disposition locations of the light-shielding regions 250 are not aligned with each other in the x-axis direction.

In detail, in each of the first dummy core 220 and the second dummy core 220 which are adjacent to each other, the multiple light-shielding regions 250 are repetitively provided in the x-axis direction at substantially equal intervals. In addition, the light-shielding regions 250 are disposed far from each other between the first dummy core 220 and the second dummy core 220 in the x-axis direction. In the example illustrated in FIGS. 12 and 13, when seen in the y-axis direction, one light-shielding region 250 in the first dummy core 220 is located at approximately the center of a line segment connecting the disposition points of two light-shielding regions 250 adjacent to each other in the second dummy core 220 (substantially on approximately the center of the wave guide region 240 in the second dummy core 220).

In the present constitution example as well, the same effects as those of the first embodiment can be obtained.

### Different Constitution Example 2

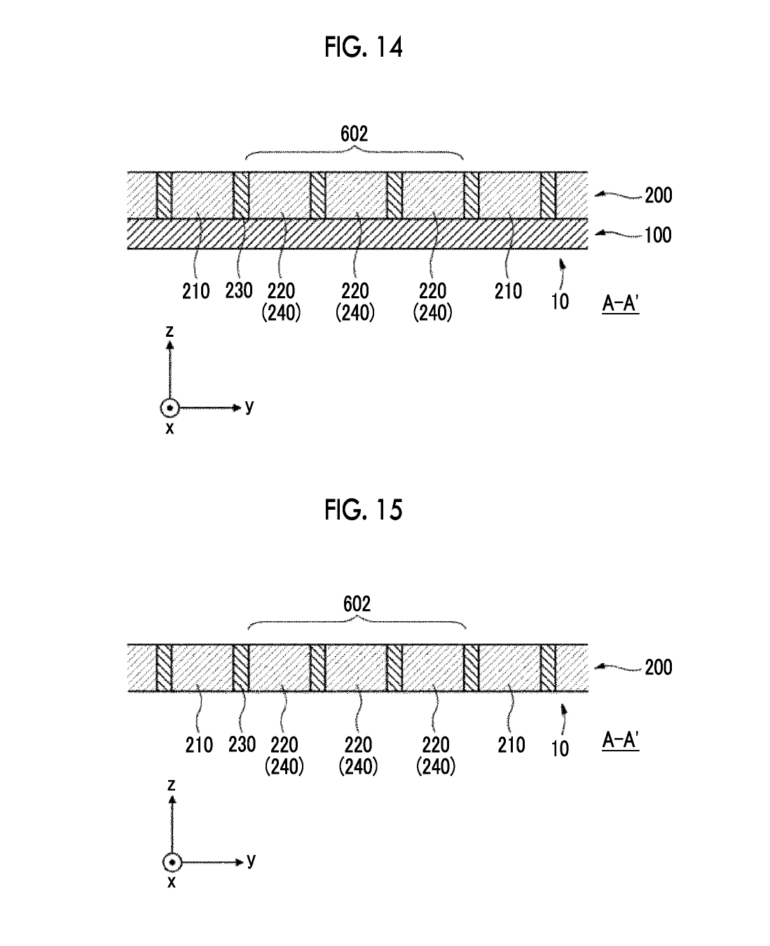

FIG. 14 is a view illustrating a different constitution example of FIG. 4 of the first embodiment. The present constitution example is the same as the first embodiment except for the fact that the clad layer 300 is not formed.

In the present constitution example as well, the core layer 200 includes the cores 210 and the dummy cores 220. In addition, the surface of the core layer 200 opposite to the clad layer 100 is in contact with gas (for example, the air) or liquid (for example, water) having a lower refractive index than that of the core 210 and the dummy core 220. In this case, the clad layer 300 may not be formed, and it is possible to confine light in the cores 210 and the dummy cores 220.

Meanwhile, on the surface of the core layer 200 opposite to the clad layer 100, a protective layer (not illustrated) may be formed. The protective layer can be formed using, for example, polyimide (PI), polyether ether ketone (PEEK), polyamide imide (PAI), polyamide (PA), polyethylene terephthalate (PET), polyether sulfone (PES), or polyethylene naphthalate (PEN).

In the present constitution example as well, the same effects as those of the first embodiment can be obtained.

### Different Constitution Example 3

FIG. 15 is a view illustrating a different constitution example of FIG. 4 of the first embodiment. The present constitution example is the same as the first embodiment except for the fact that the clad layers 100 and 300 are not formed.

In the present constitution example as well, the core layer 200 includes the cores 210 and the dummy cores 220. In addition, the top surface and the bottom surface of the core layer 200 is in contact with gas (for example, the air) or liquid (for example, water) having a lower refractive index than that of the core 210 and the dummy core 220. In this case, the clad layers 100 and 300 may not be formed, and it is possible to confine light in the cores 210 and the dummy cores 220. Meanwhile, on the top surface and the bottom surface of the core layer 200, the protective layers may be formed in the same manner as in the constitution example 2.

In the present constitution example as well, the same effects as those of the first embodiment can be obtained.

### Different Constitution Example 4

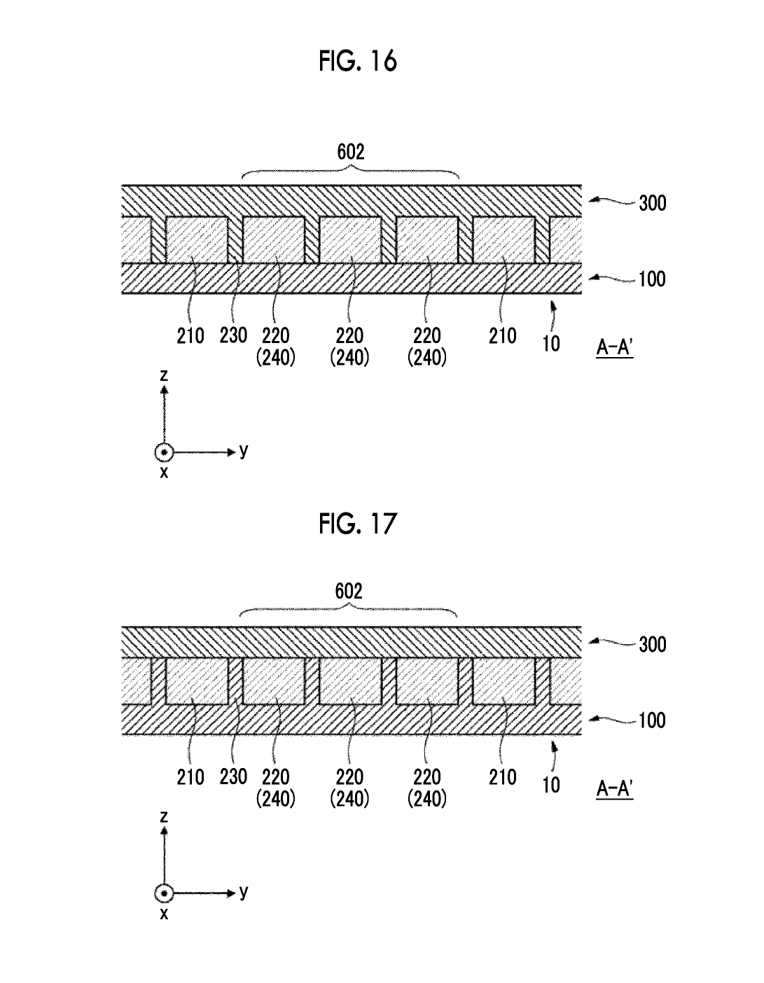

FIG. 16 is a view illustrating a different constitution example of FIG. 4 of the first embodiment. The present constitution example is the same as the first embodiment except for the following fact.

The cores 210 and the dummy cores 220 are formed on the clad layer 100. The core 210 and the dummy core 220 are separated from each other through a gap in the y-axis direction. In addition, the clad layer 300 covering the cores 210 and the dummy cores 220 is formed. In this case, some of the clad layer 300 is located in the gap and functions as the clad portion 230. Therefore, the clad layer 100 and the clad layer 300 (the clad portion 230) surround the respective cores on a cross-section (an intersection surface) substantially perpendicular to the x-axis direction of the cores. Therefore, light is confined in the cores 210 and the dummy cores 220.

In the present constitution example as well, the same effects as those of the first embodiment can be obtained.

### Different Constitution Example 5

FIG. 17 is a view illustrating a different constitution example of FIG. 4 of the first embodiment. The present constitution example is the same as the first embodiment except for the following fact.

On the surface of the clad layer 100, multiple grooves are formed separately from each other through a gap. In addition, the cores 210 and the dummy cores 220 are buried in the grooves. In this case, some of the clad layer 100 is located in the gaps and serves as the clad portion 230. On the surface on which the grooves are formed, the clad layer 300 is formed. Therefore, the clad layer 100 (the clad portion 230) and the clad layer 300 surround the respective cores on a cross-section (an intersection surface) perpendicular to the x-axis direction of the cores. Therefore, light is confined in the cores 210 and the dummy cores 220.

In the present constitution example as well, the same effects as those of the first embodiment can be obtained.

### Fourth Embodiment

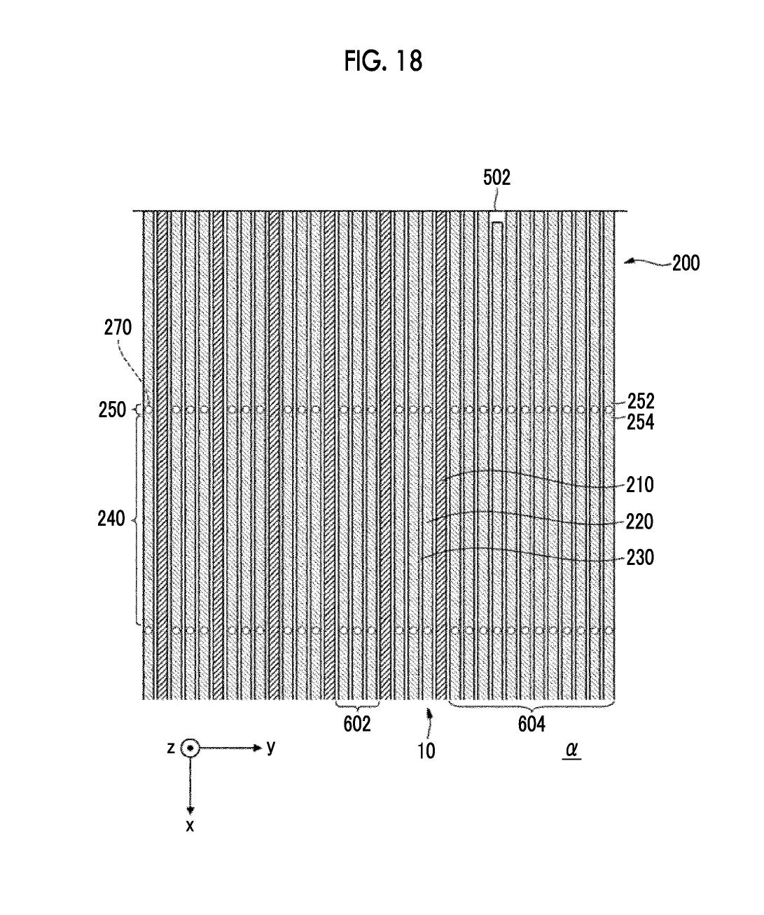

FIG. 18 is a plan view illustrating the waveguide 10 according to a fourth embodiment and corresponds to FIG. 2 of the first embodiment. The waveguide 10 according to the present embodiment has the same constitution as that of the waveguide 10 according to the first embodiment except for the fact that the dummy core 220 has a clad portion 270 in the light-shielding region 250.

The clad portion 270 is a clad portion having a circular planar shape. The refractive index of the clad portion 270 may be the same as or different from the refractive index of the clad portion 230, but is preferably the same as that. The clad portion 270 is, for example, formed from the top surface through the bottom surface of the core layer 200 as illustrated in FIG. 4 or 5. In this case, in the clad portion 270, the top surface reaches the top surface of the core layer 200, and the bottom surface reaches the bottom surface of the core layer 200.

In detail, each of the first light-shielding region 252 and the second light-shielding region 254 has a groove portion having a semi-circular planar shape on the end surface opposite to the wave guide region 240. This groove portion is substantially located at the center of the first light-shielding region 252 and the second light-shielding region 254 in the y-axis direction and reaches the top surface and the bottom surface of the core layer 200. The first light-shielding region 252 and the second light-shielding region 254 which are adjacent to each other are in contact with each other, and the clad portion 270 is located in a pore portion having a circular planar shape which is formed by the two groove portions.

In the present constitution example as well, the same effects as those of the first embodiment can be obtained.

### Examples

### Example 1

The waveguides 10 of the first embodiment having the constitutions illustrated in FIGS. 1 to 5 were manufactured. Specific conditions are as described below.

The material of the clad layer 100: polynorbornene

The polymer material of the core layer 200: polynorbornene

The monomer material of the core layer 200: oxetane monomer

The material of the clad layer 300: polynorbornene

The width of the core 210: 50 μm

The length of the core 210: 100 mm

The width of the dummy core 220: 50 μm

The length of the dummy core 220: 100 mm

The disposition intervals of the cores 210 and the dummy cores 220: 12.5 μm

The angle θ: 11.5°

The disposition interval between the light-shielding regions 250: 1,000 μm

### Example 2

The waveguide 10 having the constitution illustrated in FIG. 18 was manufactured. Specific conditions are as described below.

The material of the clad layer 100: polynorbornene

The polymer material of the core layer 200: polynorbornene

The monomer material of the core layer 200: oxetane monomer

The material of the clad layer 300: polynorbornene

The width of the core 210: 50 μm

The length of the core 210: 100 mm

The width of the dummy core 220: 50 μm

The length of the dummy core 220: 100 mm

The disposition intervals of the cores 210 and the dummy cores 220: 12.5 μm

The diameter of the clad portion 270: 30 μm

The disposition interval between the clad portions 270 (the light-shielding regions 250): 250 μm

### Comparative Example

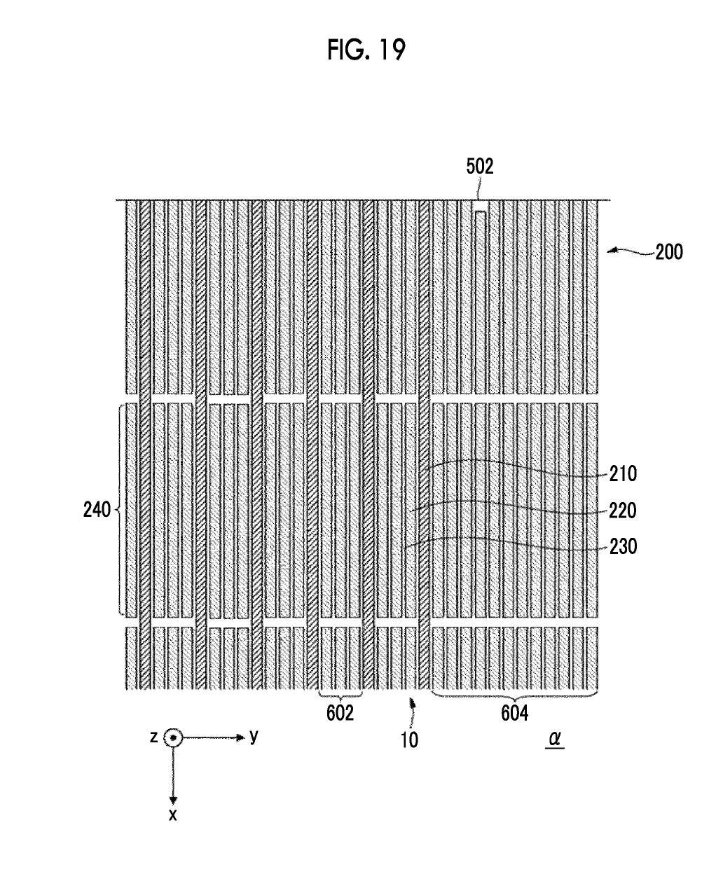

FIG. 19 is a plan view illustrating the waveguide 10 according to a comparative example and corresponds to FIG. 2 of the first embodiment. The waveguide 10 according to the comparative example has the same constitution as that of the waveguide 10 according to Example 2 except for the fact that the dummy core units adjacent to each other in the x-axis direction are disposed with a gap therebetween, and the dummy cores 220 are divided in the x-axis direction. That is, in the waveguide 10 according to the comparative example, each of the dummy core units does not have any light-shielding regions and has a rectangular planar shape.

In the comparative example, the waveguide 10 having the constitution illustrated in FIG. 19 was manufactured. Specific conditions are as described below.

The material of the clad layer 100: polynorbornene

The polymer material of the core layer 200: polynorbornene

The monomer material of the core layer 200: oxetane monomer

The material of the clad layer 300: polynorbornene

The width of the core 210: 50 μm

The length of the core 210: 100 mm

The width of the dummy core 220: 50 μm

The length of the dummy core 220: 100 mm

The disposition intervals of the cores 210 and the dummy cores 220: 12.5 μm

The separation distance between the dummy core units adjacent to each other: 30 μm

The disposition interval between the dummy core units adjacent to each other: 250 μm

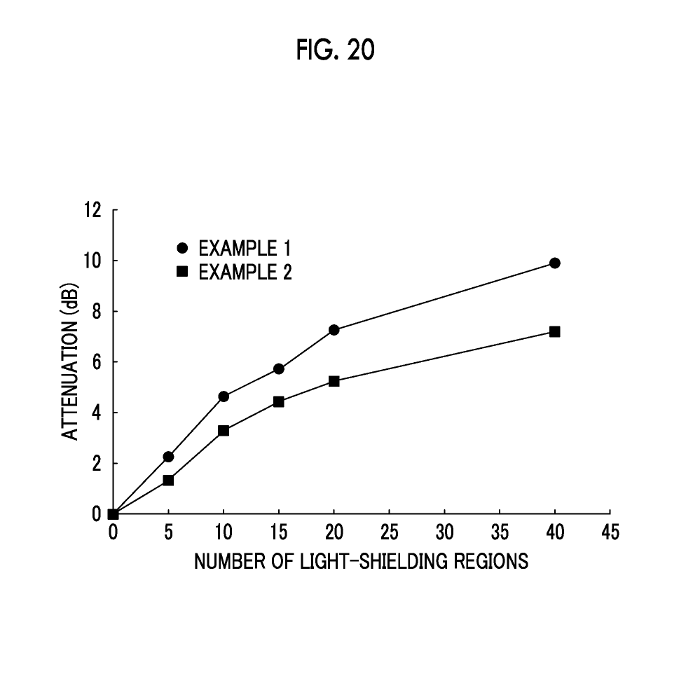

In the waveguides 10 of the respective examples and the comparative example, the same intensity of light was input to all of the cores 210 and the dummy cores 220 from the side 502 of the core layer 200. In addition, the intensity of the light from the dummy cores 220 was measured at the side 504 of the core layer 200. The attenuation of light in the dummy cores 220 was measured in the above-described manner for cases in which the number of gaps between the light-shielding regions 250 or the dummy core units adjacent to each other was 0, 5, 10, 15, 20, and 40. Meanwhile, the gaps between the light-shielding regions 250 or the dummy core units adjacent to each other were formed so as to be eccentrically located in the central portion of the dummy cores 220 in the x-axis direction. FIG. 20 is a graph illustrating a relationship between the number of the light-shielding regions and the attenuation of light in Examples 1 and 2.

Meanwhile, the attenuation of light is defined by the following expression.

Attenuation [dB]=−10 log(A504/A502)

Here, A502 represents the intensity of light from the dummy cores 220 at the side 502, and A504 represents the intensity of light from the dummy cores 220 at the side 504.

As illustrated in FIG. 20, in both Examples 1 and 2, the attenuation increases as the number of the light-shielding regions (the light-shielding regions 250) increases. Meanwhile, while not illustrated, the attenuation in the comparative example was lower than the attenuation in Example 2.

Furthermore, in the examples illustrated in FIG. 20, in a case in which the numbers of the light-shielding regions 250 are the same as each other, the attenuation is higher in Example 1 than in Example 2. In addition, in Example 1, substantially the same degree of attenuation as in Example 2 can be realized even when the number of the light-shielding regions 250 is decreased to half of that in Example 2. Furthermore, as described above, the disposition intervals between the light-shielding regions 250 is larger in Example 1 (1,000 μm) than in Example 2 (250 μm). Regardless of the above-described fact, a larger attenuation can be realized in Example 1 than in Example 2. In addition, the length of the light-shielding region 250 in the x-axis direction is smaller in Example 1 (approximately 10 him) than in Example 2 (approximately 30 μm). Regardless of the above-described fact, a larger attenuation can be realized in Example 1 than in Example 2.

The result illustrated in FIG. 20 indicates that light from the dummy cores 220 attenuates more efficiently in a case in which the light-shielding regions 250 having a taper shape (a triangular shape) are provided (Example 1) than in a case in which the circular clad portions 270 are simply provided in the middle of the dummy cores 220 in the x-axis direction (Example 2).

Hitherto, the embodiments of the present invention have been described with reference to the drawings, but the embodiments are simply examples of the present invention, and it is also possible to employ a variety of constitutions other than the embodiments. In addition, the arbitrary constitutions of the first to fourth embodiments described above may be combined together.

In the respective embodiments, in the first light-shielding regions 252 and/or the second light-shielding regions 254, the thickness is substantially constant, but the width decreases as the light-shielding region runs farther from the wave guide region 240. However, in the present invention, in the first light-shielding region 252 and/or the second light-shielding region 254, the cross-sectional area (the area of a cross-section in a direction intersecting the longitudinal direction) may decrease as the light-shielding region runs farther from the wave guide region 240. Therefore, in the first light-shielding regions 252 and/or the second light-shielding regions 254, the thickness may decrease as the light-shielding region runs farther from the wave guide region 240 while the width is substantially constant or both the width and the thickness may decrease as the light-shielding region runs farther from the wave guide region 240.

In addition, in the first to third embodiments, the cross-sectional areas (the widths) of the first light-shielding region 252 and/or the second light-shielding region 254 continuously decrease (at a constant proportion) as the light-shielding region runs farther from the wave guide region 240 but may decrease stepwise.

In addition, in the respective embodiments, each of the dummy cores 220 has multiple dummy core units provided in the x-axis direction (the first direction), but may include one dummy core unit having a length that is substantially the same as the length of the core 210 or is slightly shorter than the length of the core 210. As the dummy core unit, it is possible to use the first dummy core unit, the second dummy core unit, and the third dummy core unit.

### INDUSTRIAL APPLICABILITY

The waveguide of the present invention includes first core portions extending in a first direction, at least one second core portion which is provided parallel to the first core portions and extends in the first direction, and clad portions that separate the first core portions and the second core portions, in which the second core portion has a first region having a substantially constant cross-sectional area and a second region which is continuously provided from at least one end of the first region and has a cross-sectional area that decreases as the second region runs farther away from the first region. Therefore, it is possible to provide a waveguide in which the transmission of optical signals in the dummy cores (the second core portions) is prevented. Therefore, the present invention has an industrial applicability.

### REFERENCE SIGNS LIST

10 WAVEGUIDE
100 CLAD LAYER
200 CORE LAYER
210 CORE
220 DUMMY CORE
230 CLAD PORTION
240 WAVE GUIDE REGION (FIRST REGION)
250 LIGHT-SHIELDING REGION
252 FIRST LIGHT-SHIELDING REGION (SECOND REGION)
254 SECOND LIGHT-SHIELDING REGION (SECOND REGION)
262 END
264 END
270 CLAD PORTION
300 CLAD LAYER
502 SIDE
504 SIDE
506 SIDE

1. A waveguide comprising:
first core portions extending in a first direction;
at least one second core portion provided parallel to the first core portions and extending in the first direction; and
a clad portion that separates the first core portions and the second core portion,
wherein the second core portion has a first region having a substantially constant cross-sectional area and a second region continuously provided from at least one end of the first region, the second region having a cross-sectional area that decreases as the second region runs farther away from the first region.

2. The waveguide according to claim 1,
wherein the at least one second core portion includes multiple second core portions provided along the first direction and in contact with each other.

3. The waveguide according to claim 2,
wherein, in two of the second core portions adjacent to each other, the first region in one of the second core portions and the second region in the other second core portion are in contact with each other.

4. The waveguide according to claim 1,
wherein the at least one second core portion includes multiple second core portions provided along the first direction and separated from each other.

5. The waveguide according to claim 1,
wherein the at least one second core portion includes multiple second core portions provided along a second direction orthogonal to the first direction and separated from each other.

6. The waveguide according to claim 1,
wherein the at least one second core portion includes a second core portion having the first region and two second regions continuously provided from both ends of the first region.

7. The waveguide according to claim 1,
wherein a thickness of the second region is substantially constant, and a width of the second region decreases as the second region runs farther away from the first region.

8. The waveguide according to claim 7,
wherein, in a planar view of the waveguide, an angle formed between a side surface of the second region and a second direction orthogonal to the first direction is 5° or more and less than 90°.

9. The waveguide according to claim 1,
wherein, in a planar view of the waveguide, the second core portion has a substantially symmetric shape with respect to a central line thereof.

10. The waveguide according to claim 2,
wherein the at least one second core portion includes multiple second core portions provided along the first direction and separated from each other.

11. The waveguide according to claim 3,
wherein the at least one second core portion includes multiple second core portions provided along the first direction and separated from each other.

12. The waveguide according to claim 2,
wherein the at least one second core portion includes multiple second core portions provided along a second direction orthogonal to the first direction and separated from each other.

13. The waveguide according to claim 3,
wherein the at least one second core portion includes multiple second core portions provided along a second direction orthogonal to the first direction and separated from each other.

14. The waveguide according to claim 4,
wherein the at least one second core portion includes multiple second core portions provided along a second direction orthogonal to the first direction and separated from each other.

15. The waveguide according to claim 2,
wherein the at least one second core portion includes a second core portion having the first region and two second regions continuously provided from both ends of the first region.

16. The waveguide according to claim 3,
wherein the at least one second core portion includes a second core portion having the first region and two second regions continuously provided from both ends of the first region.

17. The waveguide according to claim 4,
wherein the at least one second core portion includes a second core portion having the first region and two second regions continuously provided from both ends of the first region.

18. The waveguide according to claim 5,
wherein the at least one second core portion includes a second core portion having the first region and two second regions continuously provided from both ends of the first region.

19. The waveguide according to claim 2,
wherein a thickness of the second region is substantially constant, and a width of the second region decreases as the second region runs farther away from the first region.

20. The waveguide according to claim 3,
wherein a thickness of the second region is substantially constant, and a width of the second region decreases as the second region runs farther away from the first region.
